(19) United States
(12) Patent Application Publication
(10) Pub. No.: US 2019/0039308 A1
(43) Pub. Date: Feb. 7, 2019

(54) APPARATUS FOR MANUFACTURING THREE-DIMENSIONAL OBJECTS

(71) Applicant: CONCEPT LASER GMBH, Lichtenfels (DE)

(72) Inventors: Florian BECHMANN, Lichtenfels (DE); Tobias Bokkes, Untersiemau (DE); Philipp Schumann, Itzgrund-Schottenstein (DE); Jürgen Werner, Lichtenfels (DE); Marie-Christin Ebert, Coburg (DE); Alexandra Popp, Bad Staffelstein (DE)

(73) Assignee: CONCEPT LASER GMBH, Lichtenfels (DE)

(21) Appl. No.: 16/054,635

(22) Filed: Aug. 3, 2018

(30) Foreign Application Priority Data
Aug. 4, 2017 (EP) 17184929.2

(51) Int. Cl. B29C 64/268; B33Y 30/00; B29C 64/159; B33Y 10/00; B29C 64/393; B33Y 50/02

(52) U.S. Cl. CPC B29C 64/268; B33Y 30/00; B33Y 50/02; B33Y 10/00; B29C 64/393; B29C 64/159

(57) ABSTRACT

Apparatus (1) for additively manufacturing of three-dimensional objects (2) by means of successive layerwise selective irradiation and consolidation of layers of a build material (3) which can be consolidated by means of an energy beam (4), wherein a detection device (13) is provided that is configured to detect splash particles (8-10) generated by at least partially evaporating build material (3) in a consolidation zone (7) in which the energy beam (4) irradiates the build material (3).

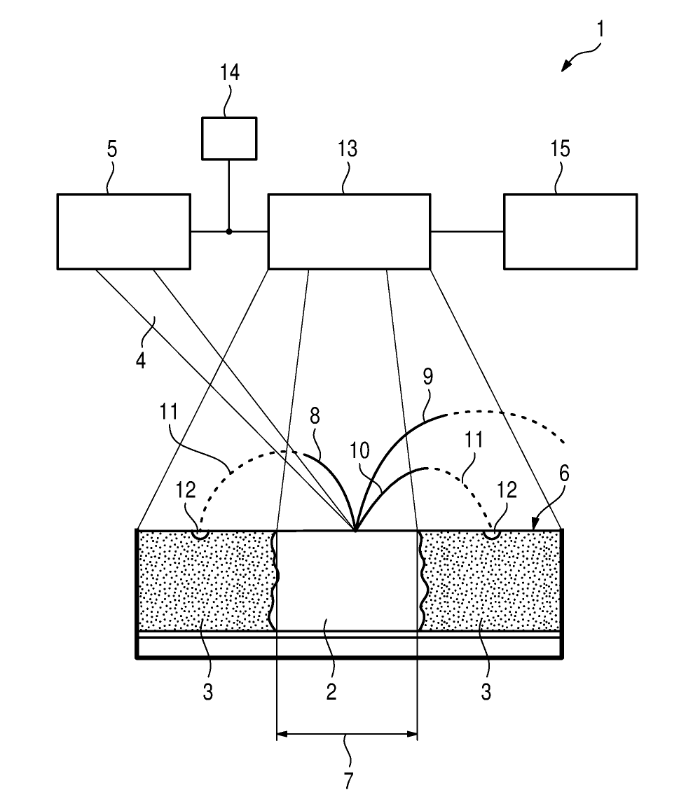

The invention relates to an apparatus for additively manufacturing of three-dimensional objects by means of successive layerwise selective irradiation and consolidation of layers of a build material which can be consolidated by means of an energy beam.

Such apparatuses are well-known from prior art, in which an energy beam is provided to selectively irradiate and thereby consolidate layers of a build material in a build plane. By successively irradiating layers of a build material an object is additively manufactured. To consolidate the build material energy is depleted in a consolidation zone via the energy beam. Dependent on various parameters, such as the energy beam power or the energy beam intensity the (powdery) build material in the consolidation zone can be sintered or melted and thereby consolidated.

It is further known from prior art that the amount of energy depleted in the build material is crucial for process quality and object quality, since if the energy depleted in the build material falls short or exceeds a defined interval or value, deviations or negative impacts on the object to be built can be the result. In particular, an exceed of energy depleted in the build material may lead to a partial evaporation of the build material, wherein splash particles are generated and distributed in and around the consolidation zone compromising the process and object quality, i.e. contaminating the powder bed around the zone the build material has been evaporated in.

Therefore, it is an object to provide an apparatus, wherein the generation of information relating to the generation of splash particles is improved.

The object is inventively achieved by an apparatus according to claim 1. Advantageous embodiments of the invention are subject to the dependent claims.

The apparatus described herein is an apparatus for additively manufacturing three-dimensional objects, e.g. technical components, by means of successive layerwise selective irradiation and consolidation of layers of a powdered build material (“build material”) which can be consolidated by means of an energy beam. A respective build material can be a metal, ceramic or polymer powder. A respective energy beam can be a laser beam or an electronic beam. A respective apparatus can be a selective laser sintering apparatus, a selective laser melting apparatus or a selective electron beam melting apparatus, for instance.

The apparatus comprises a number of functional units which are used during its operation. Exemplary functional units are a process chamber, an irradiation device which is configured to selectively irradiate a build material layer disposed in the process chamber with at least one energy beam, and a stream generating device which is configured to generate a gaseous fluid stream at least partly streaming through the process chamber with given streaming properties, e.g. a given streaming profile, streaming velocity, etc. The gaseous fluid stream is capable of being charged with non-consolidated particulate build material, particularly smoke or smoke residues generated during operation of the apparatus, while streaming through the process chamber. The gaseous fluid stream is typically inert, i.e. typically a stream of an inert gas, e.g. argon, nitrogen, carbon dioxide, etc.

The invention is based on the idea to provide a detection device that is configured to detect splash particles, e.g. generated by at least partially evaporating build material, in a consolidation zone in which the energy beam irradiates the build material. Hence, the detection device is configured to monitor at least the consolidation zone, i.e. the zone in which the energy beam irradiates the build material, wherein splash particles can be detected. Splash particles generated in the manufacturing process can therefore, be detected by means of the detection device. Splash particles as referred to in the scope of this application are typically conglomerates of build material particles and/or residues generated in the manufacturing process accelerated from a volume of build material during the manufacturing process. The splash particles are generated due to a depletion of energy in a layer of build material, wherein conglomerates of build material particles are thrown out of the volume of build material. For example, a volume of build material in which energy is depleted, e.g. via a laser beam, locally heats up, i.e. in the consolidation zone, in that build material partially evaporates. Due to the partial evaporation of build material splash particles are generated and accelerated in an essentially arbitrary manner.

The (local) entirety of generated splash particles forms a splash pattern, for example leading to a distribution of impacts of splash particles in the build plane, i.e. on the powder bed. The detection of splash particles therefore, allows for deriving information on the process and object quality and further allows for a control of at least one process parameter during the manufacturing process.

By way of the invention it is possible to monitor the generation of splash particles and/or to control the process parameter “online”, e.g. while the manufacturing process is being performed. Thus, the energy depleted in the build material by irradiation with the energy beam can be related to whether splash particles are being generated. Further, the depleted energy can be controlled, in particular reduced, when splash particles are detected. This allows for a control of process parameters, in particular the energy depleted in the build material, wherein it can be assured that the energy is chosen high enough to properly consolidate the build material but not too high as to lead to a partial evaporation of the build material.

According to a first embodiment of the apparatus, the detection device is configured to detect and/or determine a spray characteristic of the splash particles generated in the consolidation zone. The spray characteristic of the splash particles indicates whether the build material is properly consolidated or whether a part of the build material has been evaporated leading to an imperfect consolidation of the build material in the consolidation zone. Based on the spray characteristic of the splash particles it is possible to obtain information on process quality, since in processes with excessive spray of splash particles the build material is not properly consolidated leading to imperfections and/or deviations in the object to be built. Thus, it is possible to control specific process parameters, in particular the energy depleted in the build material, to ensure that a defined process quality is met.

The apparatus can further be improved in that the detection device is configured to detect the amount and/or the size and/or the speed of the splash particles and/or an impact of a splash particle on a build plane and/or a pattern of impacts of splash particles on the build plane. The term “build plane” in the scope of this application refers to the plane in which the build material can be irradiated via the energy beam. The detection of the speed of the splash particles allows for a determination of the amount of the individual splash particles, since the speed of the splash particles is correlated with the mass of the individual splash particles. For example, lighter splash particles typically move faster than heavier splash particles. Thus, the amount of build material contained in a splash particle can be determined via the mass of the splash particle by detecting the speed of the splash particle. Upon the detection of the amount and/or the size and/or the speed of the splash particles and/or an impact of a splash particle on a build plane and/or a pattern of impacts of splash particles on the build plane information can be obtained whether the manufacturing process of the three-dimensional object is performed under suitable process parameters. Hence, the amount of build material that is evaporated upon irradiation with the energy beam can be reduced, in particular minimized, to prevent the generation of splash particles that on the one hand have a negative impact on the structural integrity of the object to be built and further contaminate the powder bed in regions adjacent to the consolidation zone, wherein the splash particles land and create defects in the plane surface of the build material, e.g. craters in the build material or the splash particles land on the object being built leading to defects in the object compromising object quality.

Further, the detection device can be configured to determine a degree of evaporation of build material in the consolidation zone. Thus, the detection device allows for a determination to what degree or extent the build material is being evaporated in the consolidation zone. Upon the determination of the degree of evaporation a control of corresponding process parameters is possible to ensure that the build material is properly consolidated instead of being evaporated.

The detection device may further be configured to determine the degree of evaporation via at least one algorithm, in particular an image analysis algorithm. Thus, the detection device enables an image detection of the build plane, i.e. the consolidation zone, wherein the degree of evaporation is evaluated or determined via at least one algorithm. Using for example an image analysis algorithm it is possible to quantify or characterize the splash pattern and/or the spray characteristic of the splashes generated upon irradiation with the energy beam. This allows for an optimized control and/or regulation of various process parameters contributing to the energy depleted in the build material as the effect in adjusting such process parameters can instantly be determined or monitored via the detection device.

The apparatus can further be improved in that a control unit is provided that is configured to control at least one process parameter, preferably a parameter of the energy beam, in particular an energy beam power and/or an energy beam intensity and/or the spot size and/or the scanning speed, dependent on at least one detected splash particle and/or a detected impact of a splash particle on a build plane and/or a pattern of impacts of splash particles on the build plane and/or the determined degree of evaporation. The described embodiment allows for an “online-”monitoring and control of process parameters with respect to the energy depleted in the build material, in particular in the consolidation zone. For example, if a splash pattern is detected indicating that too much energy is depleted in the consolidation zone, relevant process parameters can be adjusted accordingly to reduce the energy depleted in the consolidation zone so as to avoid that build material is evaporated. To reduce the energy depleted in the build material it is, inter alia, possible to vary the writing speed (scanning speed), i.e. the speed the energy beam is guided over the build material, and/or to vary the size of the spot of the energy beam on the build material. It is also possible to define a threshold of detected splash particles, e.g. in number and/or size, wherein a process parameter is controlled, if the threshold is met. Thus, negative impacts on process quality can be avoided or reduced.

Additionally, the control unit of the apparatus can be configured to control at least one process parameter dependent on at least one ambient parameter in the process chamber. The ambient parameter for example is or comprises a stream of gas, in particular process gas and/or oxygen, a temperature, in particular of the process region and/or the consolidation zone. Hence, ambient parameters that additionally affect the manufacturing process can be taken into account so that the control of the process parameter leads to an enhanced process quality.

Advantageously, the detection device is or comprises at least one optical measuring device, in particular an optical sensor, for example a CMOS or CCD-sensor. Using the optical measuring device, images can be captured of the consolidation zone allowing for an evaluation, for example via an image analysis algorithm. Of course, the optical measuring device comprises suitable optical elements, such as lenses, to image the consolidation zone, in particular a generated splash pattern or generated splash particles onto the optical sensor.

According to another embodiment of the apparatus, a display unit is provided that is configured to display a detected splash particle and/or a detected impact of a splash particle on a build plane and/or a pattern of impacts of splash particles on the build plane and/or a determined degree of evaporation to a user. Thus, the information generated by the detection device can be directly displayed to the user, wherein the information can for example be further processed or used to adjust the manufacturing process. The user therefore, is informed by the display unit, wherein it is possible to use the display unit to indicate whether or not the process and/or object quality is met. Of course, the information can be stored in a quality management system.

Further, the detection device may be arranged off-axis with respect to a beam path of the energy beam. Hence, the detection device is not arranged in the beam path of the energy beam used to irradiate the build material in the consolidation zone. This allows for a continuous operation of the manufacturing process as the consolidation of build material can be monitored “online”, i.e. during the operation of the manufacturing process without the need to arrange the detection device in the beam path of the energy beam. Thus, the detection device is configured to detect splash particles as they are generated by the energy beam allowing for a direct feedback and a direct control of process parameters upon the generation of splash particles.

Besides, the invention relates to a detection device for an apparatus for additively manufacturing three-dimensional objects by means of successive layerwise selective irradiation and consolidation of layers of a build material which can be consolidated by means of an energy beam, wherein the detection device is configured to detect splash particles generated by at least partially evaporating build material in a consolidation zone in which the energy beam irradiates the build material.

Further the invention relates to a method for operating at least one apparatus for additively manufacturing of three-dimensional objects by means of successive layerwise selective irradiation and consolidation of layers of a build material which can be consolidated by means of an energy beam, wherein splash particles generated by at least partially evaporating build material in a consolidation zone in which the energy beam irradiates the build material are detected.

All features, details and advantages described with respect to the apparatus are fully transferable to the detection device and the method.

Exemplary embodiments of the invention are described with reference to the FIGURE. The sole FIGURE is a schematic diagram showing a side view of an inventive apparatus.

The sole FIGURE shows an apparatus 1 for additively manufacturing of three-dimensional objects 2 by means of successive layerwise selective irradiation and consolidation of layers of a build material 3 which can be consolidated by means of an energy beam 4. The energy beam 4 is generated by a beam generating unit 5, for example a laser beam source.

In this exemplary embodiment, the energy beam 4 is focused on a build plane 6 irradiating the build material 3 in a consolidation zone 7, wherein splash particles 8, 9 and 10 are generated, e.g. by at least partially evaporating the build material 3 in the consolidation zone 7. According to the depicted situation, the energy depleted in the build plane 6, in particular in the build material 3 located in the consolidation zone 7 of the build plane 6 that is irradiated with the energy beam 4, leads to an evaporation of a part of the build material 3. The respective partially evaporated build material 3 generates splash particles 8-10 that are moved outside the consolidation zone 7 onto the build plane 6 and thereby distributed in a process chamber of the apparatus 1. For example, the trajectories of the splash particles 8, 10 are depicted via dashed lines 11, wherein the splash particles 8, 10 create impacts 12, e.g. craters, when they impact on the surface of the build material 3 in the build plane 6 or the object 2 being built.

The apparatus 1 comprises a detection device 13 that is configured to detect the splash particles 8-10 generated in the manufacturing process, e.g. by the evaporation of the build material 3 in the consolidation zone 7. In particular, the detection device 13 is configured to monitor the entire build plane 6 as the energy beam 4 is configured to irradiate the build material 3 throughout the entire build plane 6.

The apparatus 1 further comprises a control unit 14 that is configured to control various process parameters of the manufacturing process of the three-dimensional objects 2, in particular it is possible to control the beam generating unit 5, particularly the energy beam intensity or the energy beam power of the generated energy beam 4. Futher parameters of the energy beam 4, such as a spot size of the energy beam 4 or a writing speed of the energy beam 4 may be varied as well, in particular to change the energy that is depleted in the build material 3 via the energy beam 4.

Upon a detection of splash particles 8-10 or the splash pattern the entirety of impacts 12 form on the surface of the build material 3 in the build plane 6 via the detection device 13 the corresponding process parameters can be adjusted via the control unit 14, wherein the energy depleted in the build material 3 can be regulated, particularly reduced, to reduce the degree of evaporation of the build material 3 so that the generation of splash particles 8-10 is avoided or reduced.

To detect the splash particles 8-10 the detection device 13 comprises an optical measuring device (not shown), wherein an image analysis algorithm is used to detect the generated splash particles 8-10. Thus, a spray characteristic of the splash particles 8-10 can be determined and/or detected in the consolidation zone 7. The splash particles 8-10 may be detected under a predefined angle to the build plane 6, e.g. in top view or in side view or in an arbitrary angle in between.

It is further possible to detect the amount and the size and the speed of the splash particles 8-10, i.e. the amount of build material 3 that is moved from the consolidation zone 7 due to the partial evaporation of build material 3. Further, impacts 12 of the splash particles 8-10, in other words the craters, on the build plane 6 can be detected. The single impacts 12 of splash particles 8-10 on the build plane 6, or the splash pattern the impacts 12 form on the build plane 6 can also be detected via the detection device 13. Therefore, the detection device 13 can determine whether or not predefined process quality parameters are met or whether a contamination of the build plane 6 (due to impacts 12 in the surface of the build material 3) is present. The control unit 14 can be used to (semi-)automatically control the various process parameters, in particular the energy beam power of the energy beam intensity to avoid the generation of splash particles 8-10. It is additionally possible to determine a position of an impact 12 on the build plane 6, in particular a relative position of an impact 12 of a splash particle 8-10 relative to at least one other impact 12 or relative to a consolidation zone 7.

The sole FIGURE further depicts that the apparatus 1 comprises a display unit 15 that is configured to display the detected splash particles 8-10 and the detected impacts 12 of splash particles 8-10, in particular the craters on the build plane 6 and the splash pattern of the impacts 12 of the splash particles 8-10 and the determined degree of evaporation to a user. For example, a value relating to an amount and/or a size of generated splash particles 8-10 can be displayed, as well as the specific part of the consolidation zone 7 in which the splash particles 8-10 are generated. Therefore, it is possible that alternatively or additionally the user can adjust various process parameters or can verify whether the process parameters set by the control unit 14 are suitable to ensure that a predefined process quality is met.

1. Apparatus (1) for additively manufacturing of three-dimensional objects (2) by means of successive layerwise selective irradiation and consolidation of layers of a build material (3) which can be consolidated by means of an energy beam (4),
characterized by a detection device (13) configured to detect splash particles (8-10) generated by at least partially evaporating build material (3) in a consolidation zone (7) in which the energy beam (4) irradiates the build material (3).

2. Apparatus according to claim 1, characterized in that the detection device (13) is configured to detect and/or determine a spray characteristic of the splash particles (8-10) generated in the consolidation zone (7).

3. Apparatus according to claim, characterized in that the detection device (13) is configured to detect the size and/or an amount and/or a speed of the splash particles (8-10) and/or an impact (12) of a splash particle on a build plane (6) and/or a pattern of impacts (12) of splash particles (8-10) on the build plane (6).

4. Apparatus according to claim 1, characterized in that the detection device (13) is configured to determine a degree of evaporation of build material (3) in the consolidation zone (7).

5. Apparatus according to claim 4, characterized in that the detection device (13) is configured to determine the degree of evaporation via at least one algorithm, in particular an image analysis algorithm.

6. Apparatus according to claim 2, characterized in that a control unit (14) is configured to control at least one process parameter, preferably a parameter of the energy beam (4), in particular an energy beam power and/or an energy beam intensity, dependent on at least one detected splash particle (8-10) and/or a detected impact (12) of a splash particle (8-10) on a build plane (6) and/or a pattern of impacts (12) of splash particles (8-10) on the build plane (6) and/or the determined degree of evaporation.

7. Apparatus according to claim 6, characterized in that the control unit (14) is configured to control the process parameter dependent on at least one ambient parameter.

8. Apparatus according to claim 7, characterized in that the ambient parameter is or comprises a stream of gas, in particular process gas and/or oxygen, a temperature, in particular of the process region and/or the ambience and/or the consolidation zone (7).

9. Apparatus according to claim 1, characterized in that the detection device (13) is or comprises at least one optical measuring device, in particular an optical sensor.

10. Apparatus according to claim 1, characterized by a display unit (15) configured to display a detected splash particle (8-10) and/or a detected impact (12) of a splash particle on a build plane (6) and/or a pattern of impacts (12) of splash particles (8-10) on the build plane (6) and/or a determined degree of evaporation to a user.

11. Apparatus according to claim 1, characterized in that the detection device (13) is arranged off-axis with respect to a beam path of the energy beam (4).

12. Detection device (13) for an apparatus for additively manufacturing three-dimensional objects by means of successive layerwise selective irradiation and consolidation of layers of a build material (3) which can be consolidated by means of an energy beam (4),
characterized in that the detection device (13) is configured to detect splash particles (8-10) generated by at least partially evaporating build material (3) in a consolidation zone (7) in which the energy beam (4) irradiates the build material (3).

13. Method for operating at least one apparatus (1) for additively manufacturing of three-dimensional objects (2) by means of successive layerwise selective irradiation and consolidation of layers of a build material (3) which can be consolidated by means of an energy beam (4),
characterized in that splash particles (8-10) generated by at least partially evaporating build material (3) in a consolidation zone (7) in which the energy beam (4) irradiates the build material (3) are detected.

14. Method for operating at least one apparatus (1) for additively manufacturing of three-dimensional objects (2) by means of successive layerwise selective irradiation and consolidation of layers of a build material (3) which can be consolidated by means of an energy beam (4), characterized in that splash particles (8-10) generated by at least partially evaporating build material (3) in a consolidation zone (7) in which the energy beam (4) irradiates the build material (3) are detected, the method is performed on an apparatus (1) according to claim 1.
